(19) United States
(12) Patent Application Publication
(10) Pub. No.: US 2023/0104589 A1
(43) Pub. Date: Apr. 6, 2023

(54) REPLACEABLE MOLD PART

(71) Applicant: URATANI SHOJI COMPANY LTD., Osaka-shi, Osaka (JP)

(72) Inventor: Naoto URATANI, Osaka-shi, Osaka (JP)

(21) Appl. No.: 17/802,638

(22) PCT Filed: Feb. 28, 2020
(86) PCT No.: PCT/JP2020/008558

§ 371 Date: Aug. 26, 2022

(51) Int. Cl. B29C 33/32; B29C 33/10; B29C 33/42

(52) U.S. Cl. CPC B29C 33/32; B29C 33/10; B29C 33/424; B29C 33/70

(57) ABSTRACT

A replaceable mold part according to the present invention comprises: a depressed portion remained near a cavity; and a detachable portion, the detachable portion having a marking portion or a gas-releasing function, and being caught by a catch mechanism within the depressed portion. When a magnet is brought into proximity of the detachable portion through the cavity and an external magnetic field is applied, a magnet support portion's position is shifted from the fixed location to the released location within the depressed portion so that the catch mechanism of the detachable portion by the depressed portion is switched from the fixed state to the released state, thereby the detachable portion can easily be removed from the depressed portion through the cavity.

### BACKGROUND OF THE INVENTION

### Field of the Invention

The present invention relates to a replaceable mold part associated with a marking mold part for marking the surface of a molded article during the molding or a gas-releasing mold part for releasing gas generated inside a mold.

In an injection molding machine, the mold base is opened and closed as the movable mold base is moved proximally and distally to the fixed mold base. Molten synthetic resin is injected into the cavity in the mold while the mold is closed, and then the molten synthetic resin is cured, which results in the formation of a molded article, and the molded article is ejected from the mold once the mold is opened.

When certain information is marked on the surface of the molded article, a through hole is created in the fixed or movable mold base, and a marking mold part, which has a marking face with the information embossed on the surface, is attached to the through hole. The surface of the mold part, inscribed with the information, is placed so as to be in plane with the surface of the cavity. Molten synthetic resin is injected after the mold is closed, so that the information embossed on the surface of the marking mold part is transferred to the molded article.

When the marking mold part is replaced to update the inscribed information, the marking mold part cannot be replaced by grabbing and withdrawing the marking mold part through the cavity while the mold base is open since the marking mold part is placed so that the surface thereof is in plane with the surface of the cavity, as stated above. Conventionally, it has been required to first remove the mold base itself from the injection molding machine, and then expose the back surface of the mold base, insert a stick-like jig from the back surface into the through hole, push the molded article toward the cavity with a hammer or the like, and remove the marking mold part from the mold base.

Since the mold base itself carries a heavy weight, significant workload and effort are required to remove it from the injection molding device as well as reconstruct the mold and set it in the injection molding device.

Meanwhile, the gas-releasing mold part also faces the same circumstance as the marking mold part. During injection molding, gas may be generated by high-temperature molten synthetic resin. Such gas remains inside the cavity, which locally interrupts the filling of the synthetic resin and causes defects to the molded article. In order to release gas out of the cavity, a gas-releasing mold part may be attached. The part is formed such that the front surface with a number of minute through holes is located in planar with the surface of the cavity and the back surface is in contact with the air outside of the cavity.

Since the through holes are minute, the holes may be blocked by dust and foreign objects generated within the cavity, causing a failure of the gas-releasing function. In such situation, the gas-releasing mold part is removed from the mold base and reattached after cleaning. Since the gas-releasing mold part is placed so that its front surface with the through holes is in planar with the surface of the cavity, the mold base itself needs to be removed from the injection molding machine upon replacement of the mold part, in a similar manner to the marking mold part.

### Description of Related Art

If the mold part can easily be replaced through the cavity while the mold base is open, such trouble can be saved, thereby improving the efficiency of the molding process using a mold. To date, several attempts have been reported, associated with the development of a mechanism to improve the above situation through the replacement of the marking mold part through the cavity. Japanese Patent No. 2963397 discloses a method for removing an indicator, which is a part of the marking face of the marking mold part, through the cavity. As shown in FIG. 11, the marking device A includes an outer shell member 73 fitted into the mold; an indicator 74 comprising an indication portion 741 facing an inner surface of the mold and a screw portion 742 and fitted into the outer shell member 73; and a nut 76. The nut 76 is placed at the bottom of the outer shell member 73, and the screw portion 742 of the indicator 74 is threaded to the thread groove. A spring 77 is interposed between the lower surface of the indication portion 741 and the upper portion of the outer shell member 73 so that only the indicator 74 can be removed through the cavity by rotating the indicator 74 with a screwdriver or the like and unscrewing the threaded engagement between the indicator 74 and the nut 76.

However, in the invention according to Japanese Patent No. 2963397, the marking face of the indicator needs to be inscribed with a groove in order to engage a slotted screwdriver with the indicator as well as be round-shaped as requirements, and thus, not every and any shaped marking face, such as square, can be removed. The marking mold part can be replaced through the cavity, yet such function is limited.

As shown in FIG. 12, Japanese Unexamined Patent Application Publication No. 2006-231577 discloses a method for removing the entire marking mold part through the cavity by switching between a first state in which the marking mold is maintained at a given location utilizing magnetic attraction and a second state in which the magnetic attraction is disengaged. However, a special structure needs to be formed inside the mold base for magnet movement in order to laterally move a set of magnets assembled inside the mold base, which requires a significant improvement in the mold base itself. The marking mold part can be replaced through the cavity, yet significant modification of the system is accompanied to achieve this.

### BRIEF SUMMARY OF THE INVENTION

### Problem to be Solved by the Invention

The problem to be solved by the present invention is to provide a replaceable mold part that allows for the easy replacement of the mold part having given functions, not limited to a marking face of any shape such as square or a gas-releasing part, through the cavity even while the mold base is in the open state without the need for removing the mold base itself, which carries a heavy weight, from the injection molding machine; disassembling the mold; inscribing a groove on the marking face to engage a slotted screwdriver or the like in order to attach or detach the marking face; forming a special structure within the mold base for magnetic movement or the like; or significantly modifying the mold base itself.

### Means for Solving the Problem

The invention according to a first aspect is a replaceable mold part to be attached to an indentation near a cavity in a mold base for molding process, the replaceable mold part comprising: a depressed portion provided in the indentation and remained in the cavity; and a detachable portion inserted into the depressed portion through the cavity and switched between a fixed state and a released state with respect to the depressed portion, wherein the depressed portion comprises a magnet support portion sliding in a depth direction of the depressed portion and supporting a depression-side magnet or a magnetic material piece, wherein the depressed portion further comprises a catch mechanism switching the detachable portion to the fixed state by catching the detachable portion by the depressed portion while switching the detachable portion to the released state by releasing the catch, wherein the depressed portion has a first bias means for biasing a force to control movement of the detachable portion from a fixed position to a released position, wherein the magnet support portion is provided with a fixed position and a released position of the catch mechanism, wherein the detachable portion comprises a function portion for achieving a given function, and wherein a magnetic field generated by an external magnetic field generating means overcomes the force of the first bias means to control, thereby shifting the magnet support portion from the fixed position to the released position.

The invention according to a second aspect is a replaceable mold part, wherein the function portion comprises a marking portion for marking a molded article and a gas-releasing portion for releasing gas remaining inside the cavity to outside.

The invention according to a third aspect is a replaceable mold part, wherein when, through the cavity, an operation magnet is brought into proximity of the detachable portion fixed to the depressed portion, the magnet support portion is configured to move from the fixed position to the released position by a repelling force between the depression-side magnet and the operation magnet.

The invention according to a fourth aspect is a replaceable mold part, wherein when, through the cavity, an operation magnet is brought into proximity of the detachable portion fixed to the depressed portion, the magnet support portion is configured to move from the fixed position to the released position by an attracting force between the depression-side magnet or the magnetic material piece and the operation magnet.

The invention according to a fifth aspect is a replaceable mold part, wherein the fixed position of the magnet support portion is provided at a position near an opening of the depressed portion, and the released position of the magnet support portion is provided at a position near a bottom of the depressed portion.

The invention according to a sixth aspect is a replaceable mold part, wherein the released position of the magnet support portion is provided at a position near an opening of the depressed portion, and the fixed position of the magnet support portion is provided at a position near a bottom of the depressed portion.

The invention according to a seventh aspect is a replaceable mold part, wherein the depressed portion has a tube-shaped outer shell member accommodated in the indentation, an inner tube provided inside the outer shell member, and the depression-side magnet, wherein the catch mechanism comprises at least one ball, wherein the inner tube is provided with at least one ball inlet on a side surface of the inner tube, wherein the magnet support portion has a support face supporting the depression-side magnet near an opening of the depressed portion and an extension portion extending toward a bottom of the depressed portion, wherein the extension portion is provided with an abutment face corresponding to the fixed position, and at least one ball relief corresponding to the released position, that is provided near the opening of the depressed portion than the abutment face, on an outer side surface of the extension portion, wherein the detachable portion has a top wall and a skirt portion extending in a tube shape toward the bottom of the depressed portion, wherein the skirt portion is provided with at least one ball mating indentation on an inner side surface of the skirt portion, wherein the first bias means intervenes between the bottom of the depressed portion and the lower end of the extension portion, wherein when located on the abutment face, the ball projects from the ball inlet into the ball mating indentation and is caught thereby, so that the fixed state is achieved, and wherein when located closer to the ball relief, away from the location of the ball inlet, the ball is disengaged from the catch by the ball mating indentation, so that the released state is achieved.

The invention according to an eighth aspect is a replaceable mold part, wherein the depressed portion has a tube-shaped outer shell member accommodated in the indentation, an inner tube provided inside the outer shell member, and the depression-side magnet or magnetic material piece, wherein the catch mechanism comprises at least one ball, wherein the inner tube is provided with at least one ball inlet on a side surface of the inner tube, wherein the magnet support portion has a support face supporting the depression-side magnet or the magnetic material piece near the opening of the depressed portion and an extension portion extending toward a bottom of the depressed portion, wherein the extension portion is provided with an abutment face corresponding to the fixed position, and at least one ball relief corresponding to the released position, that is provided near the bottom of the depressed portion than the abutment face, on an outer side surface of the extension portion, wherein the detachable portion has a top wall and a skirt portion extending in a tube shape toward the bottom of the depressed portion, wherein the skirt portion is provided with at least one ball mating indentation on an inner side surface of the skirt portion, wherein the first bias means intervenes between the bottom of the depressed portion and the extension portion, wherein when located on the abutment face, the ball projects from the ball inlet into the ball mating indentation and is caught thereby, so that the fixed state is achieved, and wherein when located closer to the ball relief, away from the location of the ball inlet, the ball is disengaged from the catch by the ball mating indentation, so that the released state is achieved.

The invention according to a ninth aspect is a replaceable mold part, wherein the replaceable mold part has a tube-shaped outer tube inserted inside the outer shell member and positioned outside in a state of surrounding the inner tube, and wherein the outer tube is biased by a second bias means interposed between a bottom of the outer tube and a bottom of the outer shell member in the direction toward the opening of the depressed portion.

The invention according to a tenth aspect is a replaceable mold part, wherein the depressed portion has a tube-shaped outer shell member accommodated in the indentation, an inner tube provided inside the outer shell member, and the depression-side magnet in a ring shape, wherein the catch mechanism comprises at least one ball, wherein the inner tube is provided with at least one ball inlet on a side surface of the inner tube, wherein the magnet support portion conforms to a ring shape, and has a support face supporting the depression-side magnet near the opening of the depressed portion and an extension portion extending toward a bottom of the depressed portion, wherein the extension portion is provided with an abutment face corresponding to the fixed position, and at least one ball relief corresponding to the released position, that is provided near the face of the opening of the depressed portion than the abutment face, on an inner side surface of the extension portion, wherein the detachable portion has a top wall and an axial portion extending in an axial shape toward the bottom of the depressed portion, wherein the axial portion is provided with at least one ball mating indentation on an outer side surface of the axial portion, wherein the first bias means intervenes between the bottom of the depressed portion and the extension portion, wherein when located on the abutment face, the ball projects from the ball inlet into the ball mating indentation and is caught thereby, so that the fixed state is achieved, and wherein when located closer to the ball relief, away from the location of the ball inlet, the ball is disengaged from the catch by the ball mating indentation, so that the released state is achieved.

The invention according to an eleventh aspect is a replaceable mold part, wherein the depressed portion has a tube-shaped outer shell member accommodated in the indentation, an inner tube provided inside the outer shell member, and the depression-side magnet or the magnetic material piece in a ring shape, wherein the catch mechanism comprises at least one ball, wherein the inner tube is provided with at least one ball inlet on a side surface of the inner tube, wherein the magnet support portion conforms to a ring shape, and has a support face supporting the depression-side magnet or the magnetic material piece near the opening of the depressed portion and an extension portion extending toward a bottom of the depressed portion, wherein the extension portion is provided with an abutment face corresponding to the fixed position, and at least one ball relief corresponding to the released position, that is provided near the bottom of the depressed portion than the abutment face, on an inner side surface of the extension portion, wherein the detachable portion has a top wall and an axial portion extending in an axial shape toward the bottom of the depressed portion, wherein the axial portion is provided with at least one ball mating indentation on an outer side surface of the axial portion, wherein the first bias means intervenes between the bottom of the depressed portion and the extension portion, wherein when located on the abutment face, the ball projects from the ball inlet into the ball mating indentation and is caught thereby, so that the fixed state is achieved, and wherein when located closer to the ball relief, away from the location of the ball inlet, the ball is disengaged from the catch by the ball mating indentation, so that the released state is achieved.

The invention according to a twelfth aspect is a replaceable mold part, wherein the replaceable mold part has a pushing portion slidably inserted inside the inner tube and facing a bottom of the depressed portion, wherein the pushing portion is biased by a second bias means interposed between a bottom of the pushing portion and the bottom of the depressed portion in the direction toward the opening of the depressed portion.

The invention according to a thirteenth aspect is a replaceable mold part, wherein the replaceable mold part is provided with a through hole penetrating the detachable portion and the depressed portion, and the mold base is provided with a vent hole communicating with the through hole in the depressed portion in advance, and wherein the depression-side magnet or the magnetic material piece is disposed in a manner to avoid the disposal position of the through hole.

The invention according to a fourteenth aspect is a replaceable mold part, wherein the detachable portion is provided with at least one positioning ridge on a side surface of the detachable portion, that projects laterally against the outer shell member, and wherein the outer shell member is provided with at least one positioning groove in the inner wall of the outer shell member, that extends in the depth direction while enabling the positioning ridge to be fitted therein.

The invention according to a fifteenth aspect is a replaceable mold part, wherein the detachable portion is provided with at least one positioning projection on a side surface of the detachable portion, that projects laterally against the outer shell member, wherein the positioning projection comprises a positioning spring embedded under the side surface of the detachable portion and a fitting portion disposed on the positioning spring, and wherein at least one positioning indentation is formed on the inner surface of the outer shell member, that enables the fitting portion to be fitted therein.

The invention according to a sixteenth aspect is the replaceable mold part according to any one of the first to fifteenth aspects that has an operation magnet handling jig, wherein the replaceable mold part is equipped with a magnet-positioning means for locating the operation magnet directly above the replaceable mold part of the mold base for molding process, and a distance altering means for altering the distance between the operation magnet and the replaceable mold part.

The invention according to a seventeenth aspect is the replaceable mold part according the sixteenth aspect that has an operation magnet handling jig, wherein the operation magnet handling jig comprises a magnet-holding container, a positioning base, a third bias means, an operation magnet, and a buffer sheet, wherein the operation magnet is accommodated inside the magnet-holding container, wherein the buffer sheet is bonded to the lower surface of the operation magnet, wherein the magnet-holding container accompanied by the operation magnet is slidably fitted in the positioning base, and wherein the distance between the lower end of the positioning base and the lower end of the operation magnet is maintained by a repelling force urged by the third bias means interposed between the positioning base and the magnet-holding container.

### Effects of the Invention

According to the invention of the first aspect of the present invention, the replaceable mold part comprises a depressed portion remaining near the cavity and a detachable portion, and the detachable portion is caught by a catch mechanism within the depressed portion. The magnet support portion is shifted from the fixed location to the released location by application of an external magnetic field, so that the catch mechanism of the detachable portion by the depressed portion is switched from the fixed state to the released state, thereby the detachable portion can be removed from the depressed portion through the cavity. This allows for the easy replacement of the detachable portion, which is a part of the mold part, by applying an external magnetic field while the mold base is in the open state, without the need for removing the mold base itself, which carries a heavy weight, from the injection molding machine or disassembling the mold.

According to the invention of the second aspect of the present invention, the replaceable mold part allows for the achievement of a function of marking on the surface of a molded article and a function of releasing gas generated during molding process. Here, the function of marking refers to the function of forming various information on the surface of the molded article, including barcode, QR Code (registered trademark), various marks, production date and production number.

According to the invention of the third aspect of the present invention, the replaceable mold part allows for the achievement of removal of the detachable portion through the cavity by the repelling force between the two magnets when the operation magnet is brought into proximity of the replaceable mold part according to the present invention. This can be achieved when the magnet support portion is moved from the fixed state to the released position due to the repelling force between the two magnets and the catch of the catch mechanism by the depressed portion is released.

According to the invention of the fourth aspect of the present invention, the replaceable mold part allows for the achievement of removal of the detachable portion through the cavity by the attracting force between the two magnets when the operation magnet is brought into proximity of the replaceable mold part according to the present invention. This can be achieved when the magnet support portion is moved from the fixed state to the released position due to the attracting force between the two magnets and the catch of the catch mechanism by the depressed portion is released.

According to the invention of the fifth aspect of the present invention, the fixed position of the magnet support portion is set near the opening of the depressed portion, and the released position is set near the bottom of the depressed portion. When the magnet support portion is moved toward the bottom of the depressed portion by an externally applied magnetic field, the catch mechanism can be released.

According to the invention of the sixth aspect of the present invention, the fixed position of the magnet support portion is set near the bottom of the depressed portion, and the released position is set near the opening of the depressed portion. When the magnet support portion is moved toward the opening of the depressed portion by an externally applied magnetic field, the catch mechanism can be released.

According to the invention of the seventh aspect of the present invention, the replaceable mold part allows for the achievement of fixing to and releasing from the depressed portion, of the detachable portion in response to the catch state and the non-catch state between the ball and the ball mating indentation. This mechanism can provide reliable, accurate operation due to its simple structure.

According to the invention of the eighth aspect of the present invention, the replaceable mold part allows for the achievement of fixing to and releasing from the depressed portion, of the detachable portion in response to the catch state and the non-catch state between the ball and the ball mating indentation. This mechanism can provide reliable, accurate operation due to its simple structure. When a magnetic material piece is used instead of the depression-side magnet, iron powder and the like will no longer be attracted to the function portion due to the magnetic force and no defect will occur in the molded article.

According to the invention of the ninth aspect of the present invention, when the catch of the detachable portion by the catch mechanism is released by an externally applied magnetic field, the detachable portion moves toward the face of the opening of the depressed portion since the detachable portion is constantly biased through contact with the outer tube. As a result, part of the detachable portion projects beyond the surface of the cavity, thereby the detachable portion can be grabbed and removed through the cavity.

According to the invention of the tenth aspect of the present invention, the replaceable mold part allows for the achievement of fixing to and releasing from the depressed portion, of the detachable portion in response to the catch state and the non-catch state between the ball and the ball mating indentation. This mechanism can provide reliable, accurate operation due to its simple structure.

According to the invention of the eleventh aspect of the present invention, the replaceable mold part allows for the achievement of fixing to and releasing from the depressed portion, of the detachable portion in response to the catch state and the non-catch state between the ball and the ball mating indentation. This mechanism can provide reliable, accurate operation due to its simple structure. When a magnetic material piece is used instead of the depression-side magnet, iron powder will no longer be attracted to the function portion due to the magnetic force and no defect will occur in the molded article.

According to the invention of the twelfth aspect of the present invention, when the catch of the detachable portion by the catch mechanism is released by an externally applied magnetic field, the detachable portion moves toward the face of the opening of the depressed portion since the detachable portion is constantly biased through contact with the pushing portion. As a result, part of the detachable portion projects beyond the surface of the cavity, thereby the detachable portion can be grabbed and removed through the cavity.

According to the invention of the thirteenth aspect of the present invention, the replaceable mold part allows for the realization of a structure with a through hole that penetrates the detachable portion and the depressed portion in the depth direction. This allows for the release of the gas present in the internal space while the mold base is in the closed state, to the outside. The present invention enables easy cleaning of the through hole without the need for disassembling the mold even when the through hole is blocked, since the detachable portion comprising the through hole can be removed and reattached through the cavity while the mold base is in the open state.

According to the invention of the fourteenth aspect of the present invention, the replaceable mold part allows for the definition of the direction of the function portion inside the cavity. In particular, when the detachable portion has a cylinder shape, it is highly effective in preventing the rotation around the central axis that penetrates the cylindrical shape in the depth direction.

According to the invention of the fifteenth aspect of the present invention, the replaceable mold part allows for the fixation of the direction of the function portion inside the cavity. In particular, if the detachable portion has a cylinder shape, it allows for the prevention of the rotation around the central axis that penetrates the cylindrical shape in the depth direction, which would be caused when an external force of external disturbance is applied. In contrast, when a strong force is intentionally applied to the detachable portion such as by inscribing a groove on the surface of the function portion and rotating the detachable portion with a screwdriver or the like, the mating portion is embedded inside the side surface of the detachable portion due to the contraction of the positioning spring, thereby the obstacle for the rotation is removed and the detachable portion can be rotated. That is, while no rotation occurs by a weak force of disturbance, the rotation of the detachable portion can occur when a strong force is applied with an intention to rotate the detachable portion, without the need for removing the detachable portion using the operation magnet. As a matter of course, if necessary, the detachable portion itself can also be removed using the operation magnet.

According to the invention of the sixteenth aspect of the present invention, the replaceable mold part enables accurate positioning of the operation magnet during the removal of the detachable portion from the depressed portion.

According to the invention of the seventeenth aspect of the present invention, the replaceable mold part enables accurate positioning of the operation magnet during the removal of the detachable portion from the depressed portion as well as protection of the surface of the cavity in the mold base against sudden contact with the operation magnet.

### BRIEF DESCRIPTION OF DRAWINGS

FIG. 1 is a longitudinal sectional view illustrating the relation of a replaceable mold part according to the present invention with a mold base when the mold base is closed.

FIG. 2 is a longitudinal sectional view illustrating the relation of a replaceable mold part according to the present invention with a mold base when the mold base is open.

FIG. 3 is a longitudinal sectional view of a push type cylinder-shaped replaceable mold part according to the present invention cut in the depth direction. Part (a) illustrates the state in which a detachable portion is fixed to a depressed portion, while part (b) illustrates the state in which the detachable portion is released.

FIG. 4 is a longitudinal sectional view of a pull type cylinder-shaped replaceable mold part according to the present invention cut in the depth direction. Part (a) illustrates the state in which a detachable portion is fixed to a depressed portion, while part (b) illustrates the state in which the detachable portion is released.

FIG. 5 is a view of an example of an attempt to maximize the volume of a magnetic material support portion in a pull type, cylinder-shaped replaceable mold part according to the present invention. Part (a) is a transverse sectional view of the state in which a detachable portion is fixed to a depressed portion, cut along A-A′ in the transverse direction, part (b) is a longitudinal sectional view cut along A-A′ in the depth direction, part (c) is a longitudinal sectional view cut along B-B′ in the depth direction, and part (d) is a perspective view of the detachable portion.

FIG. 6 is a sectional view of a pull type, ring-shaped replaceable marking mold part according to the present invention. Part (a) illustrates the state in which a detachable portion is fixed to a depressed portion, while part (b) illustrates the state in which the detachable portion is released.

FIG. 7 is a sectional view of a push type replaceable gas-releasing mold part according to the present invention. Part (a) illustrates the state in which a detachable portion is fixed to a depressed portion, while part (b) illustrates the state in which the detachable portion is released.

FIG. 8 is a view illustrating the relation between a ridge and a slit provided in a replaceable mold part according to the present invention. Part (a) is a transverse sectional view of the mold part cut along the C-C′ line shown in part (b) in the transverse direction, and part (b) is a longitudinal sectional view of the mold part cut along the C-C′ line shown in part (a) in the depth direction.

FIG. 9 is a view illustrating the relation between a positioning projection and an indentation provided in a replaceable mold part according to the present invention. Part (a) is a transverse sectional view of the mold part cut along the D-D′ line shown in part (b) in the transverse direction, and part (b) is a longitudinal sectional view of the mold part cut along the D-D′ line shown in part (a) in the depth direction.

FIG. 10 is a sectional view of an operation magnet handling jig according to the present invention. Part (a) illustrates the state in which an operation magnet is away from a cavity, and part (b) illustrates a case in which the operation magnet is in the proximity of the cavity.

FIG. 11 is a view illustrating a conventional mold part.

FIG. 12 is a view illustrating a conventional mold part.

### DETAILED DESCRIPTION OF THE INVENTION

Embodiments of a replaceable mold part according to the present invention are described below with reference to the drawings.

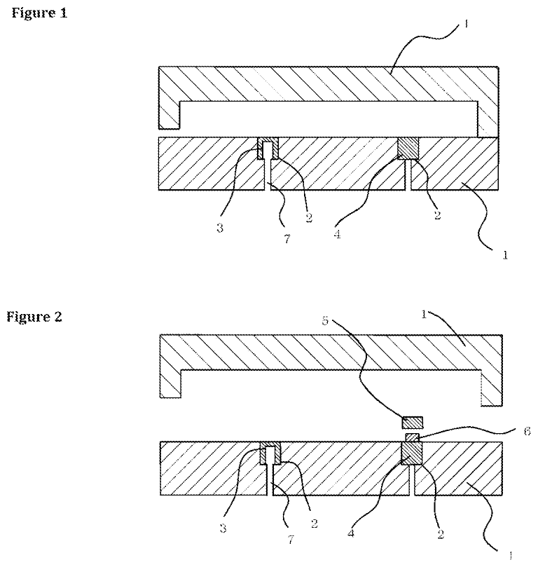

FIG. 1 is a view illustrating the position of a replaceable mold part according to the present invention within an injection molding machine. When certain information is marked on the surface of a molded article, as shown in FIG. 1, an indentation 2 is created on a fixed or movable mold base 1, and a marking mold part 4 according to the present invention, which has a marking face with the information embossed on the surface, is attached to the indentation 2. The surface of the mold part 4, inscribed with the information, is adjusted so as to be in plane with the surface of the cavity. Molten synthetic resin is injected after the mold base is closed, so that the information embossed on the surface of the marking mold part is transferred to the molded article. This applies not only to molds for molding process using synthetic resin, but also molds for molding process using aluminum or the like in Examples of the present invention.

When the marking face of the replaceable mold part according to the present invention is to be replaced, the mold base is opened as shown in FIG. 2, and an operation magnet 5 is brought into proximity thereof through the cavity. As the engagement of a detachable portion 6 with the depressed portion within the mold part is released, the detachable portion 6 projects beyond the surface of the cavity, thereby the projection portion can be grabbed to remove the detachable portion 6 through the cavity.

The indentation includes a through hole because a through hole is recognized as an indentation when viewed from the surface of the cavity in the mold base.

A gas-releasing mold part 3 is also shown in FIGS. 1 and 2. The detachable portion in the gas-releasing mold part 3 is attached and removed in a similar manner to the marking mold part as stated above.

### First Embodiment

Firstly, the marking mold part is described with reference to the drawings. A replaceable mold part according to the present invention is categorized into two types depending on its structure: the push type that the fixation of the detachable portion to the depressed portion is released by the repelling force between the depression-side magnet embedded in the mold part and the operation magnet, and the pull type that the aforementioned fixation is released by the attracting force.

### Configuration of Push Type

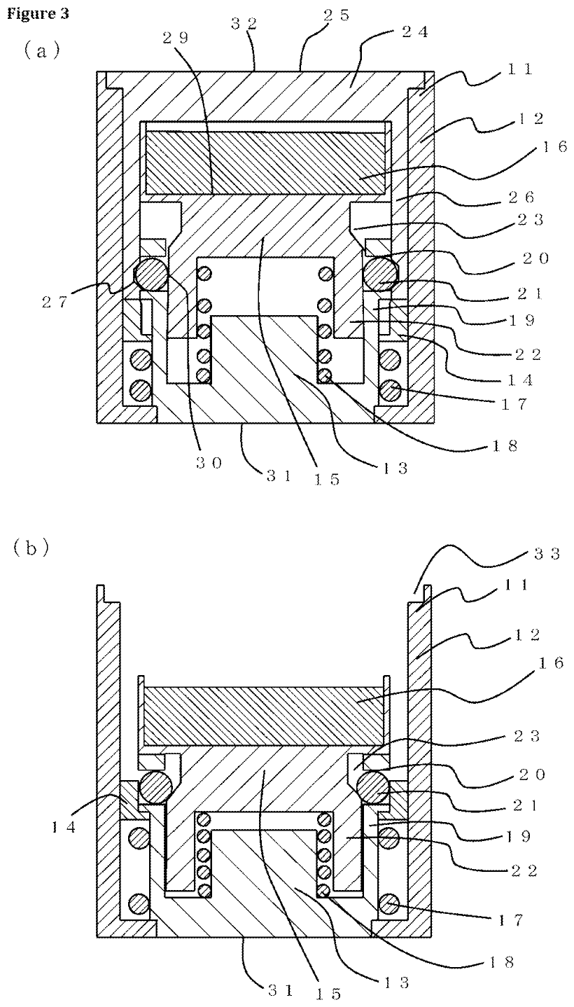

Part (a) of FIG. 3 shows a sectional view of the state in which no magnetic field acts on the detachable portion and the detachable portion 24 is fixed to the depressed portion 11 in the push type marking mold part. Part (b) of FIG. 3 shows a sectional view of the state in which the detachable portion 24 is released from the depressed portion 11.

The depressed portion 11 comprises an outer shell member 12, a cover member 13, an outer tube 14, a magnet support portion 15, a depression-side magnet 16, and a first and a second bias means 18 and 17.

The outer shell member 12 is tube-shaped outer shell located in the outermost shell.

The cover member 13 is engaged with an end of the outer shell member 12 to form the bottom surface of the tube, and comprises a bottom 31 and an inner tube 19 extending in a tube shape from the bottom 31 toward the opening of the depressed portion, where the inner tube 19 is provided with at least one ball inlet 20 on the side surface and a ball 21 corresponding to the ball inlet.

The outer tube 14 is tube-shaped, fitted inside of the outer shell member 12 and located outside in a state of surrounding the inner tube 19, where the outer side surface of the outer tube is slidably in contact with the inner side of the outer shell member 12, and the inner side surface of the outer tube is slidably in contact with the outer side surface of the inner tube of the cover member 13.

The bottom of the outer tube 14 is biased upward by the second bias means 17 interposed between the bottom of the outer tube 14 and the bottom of the outer shell member 12. Generally, an elastic means is adapted as such bias means. Although a spring, leaf spring, or the like can be used as the elastic means, this configuration employs a coil spring.

The magnet support portion 15 comprises a support face 29 supporting the depression-side magnet 16 near the opening of the depressed portion and an extension portion 22 extending toward the bottom thereof. The depression-side magnet 16 is arranged on the support face 29 so that the N pole faces the opening of the depressed portion. The extension portion 22 is inserted further inside the inner tube 19 of the cover member through the opening of the depressed portion, and the outer side surface of the extension portion is slidably in contact with the inner side surface of the inner tube.

A ball relief 23 is present at at least one location on the outer side surface of the extension portion 22 and in the proximity of the opening of the depressed portion in the depth direction. The magnet support portion 15 is biased upward by the first bias means 18 interposed between the magnet support portion 15 and the upper surface of the cover member, so that the magnet support portion 15 is located at a position close to the opening of the depressed portion.

The detachable portion 24 is inserted into the outer shell member 12 through the opening 33 of the depressed portion. The detachable portion 24 comprises a top wall 25 forming an end of the outer shell member 12, and a skirt portion 26 extending in a tube shape from the top wall 25 in the direction toward the bottom. The skirt portion 26 is slidably mated inside the outer shell member 12, and the inner side surface of the skirt portion 26 is slidably in contact with the outer side surface of the inner tube 19. The function portion 32 is placed on the top wall 25, and provides a function such as marking or releasing gas.

The lower surface of the skirt portion 26 is in contact with the upper surface of the outer tube 14 and biased by the second bias means 17 through the outer tube 14 in the direction toward the opening of the depressed portion, and the inner side surface of the skirt portion 26 is provided with at least one ball mating indentation 27.

### Movement of Push Type

When no magnetic field acts on the replaceable mold part according to the present invention, the magnet support portion 15 is supported only by the first bias means 18 and the first bias means 18 maintains its natural length, more or less. At this location, the ball 21 abuts against the abutment face 30 of the extension portion 22 of the magnet support portion, and part of the ball 21 projects from the ball inlet 20 into the ball mating indentation 27 provided in the skirt portion 26 and caught thereby, so that the detachable portion 24 is fixed within the depressed portion 11.

This structure is maintained by the force that the outer tube 14 biased upward by the second bias means 17 pushes the lower end of the skirt portion 26. Thus, stress is applied to the ball 21 through the ball mating indentation 27 so that the ball 21 is tightly fitted in the space surrounded by the abutment face 30, the ball inlet 20 and the ball mating indentation 27 while the detachable portion 24 is tightly fixed to the depressed portion 11.

As shown in FIG. 2, if the operation magnet 5 is brought into proximity of the replaceable mold part through the cavity in the mold plate so that the N pole is directed toward the replaceable mold part, then the depression-side magnet 16 is switched from the state of part (a) of FIG. 3 and pushed toward the bottom surface of the depressed portion by the repelling force. The first bias means 18 is compressed, and the magnet support portion 15 moves to the position near the bottom surface. Part (b) of FIG. 3 shows the state after the movement.

The ball 21 moves laterally from the ball mating indentation 27 of the skirt portion toward the ball relief 23 provided on the side surface of the magnet support portion. When located closer to the ball relief 23, away from the ball inlet 20, the ball 21 is disengaged from the catch by the ball mating indentation 27, thereby the fixation of the detachable portion 24 to the depressed portion 11 is released.

Since the skirt portion 26 is constantly biased toward the opening of the depressed portion, the skirt portion 26 moves so that the skirt portion is pushed upward toward the opening of the depressed portion once the ball 21 is disengaged from the catch by the ball mating indentation 27. As a result, the top of the detachable portion 24 projects beyond the surface of the cavity in the mold base, thereby the projecting portion can be grabbed to remove the detachable portion 24.

When the detachable portion 24 is attached to the depressed portion, the detachable portion 24 is inserted through the face of the opening of the depressed portion in the state of part (b) of FIG. 3 and pushed downward against the force of the second bias means, thereby the ball 21 mates with the ball mating indentation 27 once again and is removed from the ball relief 23. In this aspect, the bias force of the first bias means also serves the following two functions in cooperation with the second bias means. Firstly, the bias force of the first bias means provides a component of lateral force to the ball 21 by the tapered slope in the ball relief 23, so that the ball 21 is removed from the ball mating indentation 27 in the lateral direction. Secondly, the bias force of the first bias means pushes upward the magnet support portion released from the catch, so that the magnet support portion returns to the original location. According to the above, the detachable portion can return to the original caught state as shown in part (a) of FIG. 3.

### Configuration of Pull Type

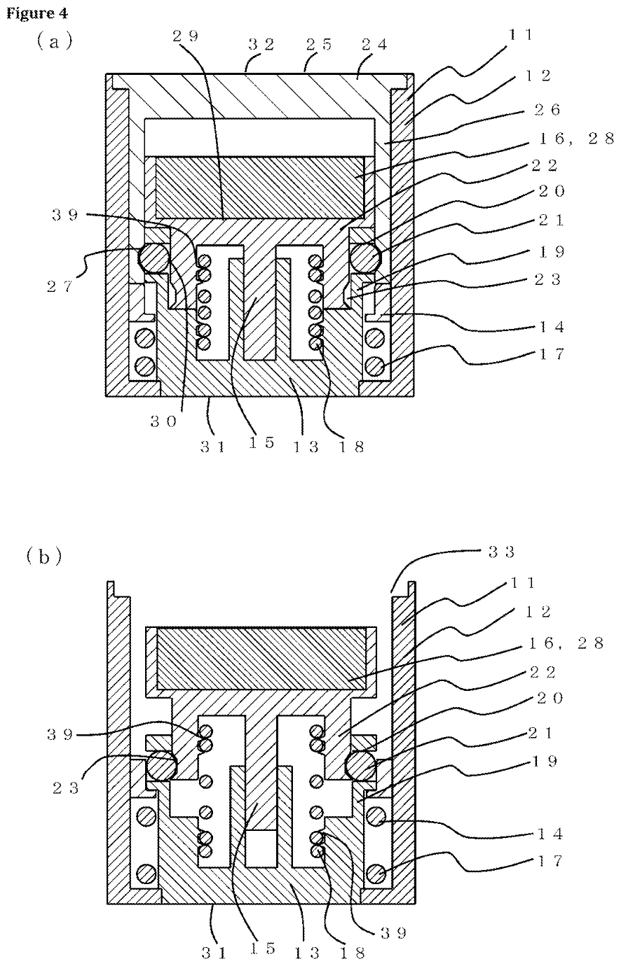

Now, the pull type, the type that releases the engagement of the detachable portion 24 with the depressed portion 11 by the attracting force of the depression-side magnet 16 embedded in the depressed portion 11 and of the operation magnet 5, is described with reference to FIG. 4. Those members that have similar functions or effects to those of the components described for the push type as shown in FIG. 3 are denoted by the same reference numerals, and their descriptions are omitted.

Part (a) of FIG. 4 shows a sectional view of the state in which no magnetic field is acting and the detachable portion 24 is caught by the depressed portion 11. There are two differences between the pull type and the push type. Firstly, with respect to the outer surface of the extension portion 22, while the push type has the ball relief 23 located in a place close to the opening of the depressed portion, the pull type has the ball relief 23 located in a place close to the bottom of the depression portion. Secondly, with respect to a case where no magnetic field is acting, while the push type has the magnet support portion 15 biased upward by the first bias means 18 interposed between the magnet support portion 15 and the upper surface of the cover member and located close to the opening of the depressed portion, the pull type has the magnet support portion 15 biased downward and located close to the bottom of the depressed portion.

In the pull type, the depression-side magnet 16 embedded in the depressed portion 11 does not have to be a magnet. Since it merely needs to cause the attracting force between the depression-side magnet 16 and the operation magnet 5, a magnetic material piece 28 may be present, instead of a magnet, at the location of the above depression-side magnet 16. A magnetic material means an object that causes magnetic force to the extent that the magnet support portion 15 can be moved by the externally applied magnetic field.

To begin with, following issues arise when a magnet is embedded in the depressed portion 11. Firstly, the structure becomes complexed, thereby the mass productivity decreases; and secondly, metal powder and the like are drawn to the surface of the function portion 32 of the mold part due to the magnetic force, thereby defects may occur in the resin molded article. The pull type, in which a magnet is not necessarily used in the depressed portion, has a significant advantage over the push type.

### Movement of Pull Type

If the operation magnet 5 is brought into proximity, the depression-side magnet 16 is pulled toward the opening of the depressed portion by the attracting force. The first bias means 18 is then extended, and the magnet support portion 15 moves to a position close to the opening of the depressed portion. Part (b) of FIG. 4 shows the state after the movement. The polarity of the operation magnet 5 that is directed toward the mold part needs to be an S pole if a magnet is embedded in the depressed portion 11; however, the polarity of the operation magnet 5 may be either an S pole or an N pole if a magnetic material is embedded.

The ball 21 moves laterally from the ball mating indentation 27 of the skirt portion toward the ball relief 23 provided on the side surface of the magnet support portion. When located closer to the ball relief 23, away from the location of the ball inlet 20, the ball 21 is disengaged from the catch by the ball mating indentation 27, thereby the fixation of the detachable portion 24 to the depressed portion 11 is released.

Since the skirt portion 26 is biased toward the opening of the depressed portion, the skirt portion 26 moves in the same direction. As a result, the top of the detachable portion 24 projects beyond the surface of the cavity in the mold base, thereby the projecting portion can be grabbed to remove the detachable portion 24.

When the detachable portion 24 is attached to the depressed portion 11, the detachable portion 24 is inserted through the opening of the depressed portion in the state of part (b) of FIG. 4 and the ball 21 is mated with the ball mating indentation 27 once again, which results in the removal of the ball 21 from the ball relief 23. Thus, the detachable portion can return to the caught state as shown in part (a) of FIG. 4.

### Maximization of Magnetic Material Volume in Pull Type

It has already been stated that the depression-side magnet 16 embedded in the depressed portion 11 does not have to be a magnet in the pull type. However, when a magnetic material is used, the attracting force caused between the magnetic material and the operation magnet 5 becomes weaker as compared to that caused when a magnet with the same volume is used. Therefore, there is a need to supplement the weakened attracting force by increasing the volume of the magnetic material as much as possible. It is contemplated that the depression-side magnet 16 and the magnet support portion 15 can be integrated and this integrated part itself can be made of a magnetic material in order to increase the volume of the magnetic material.

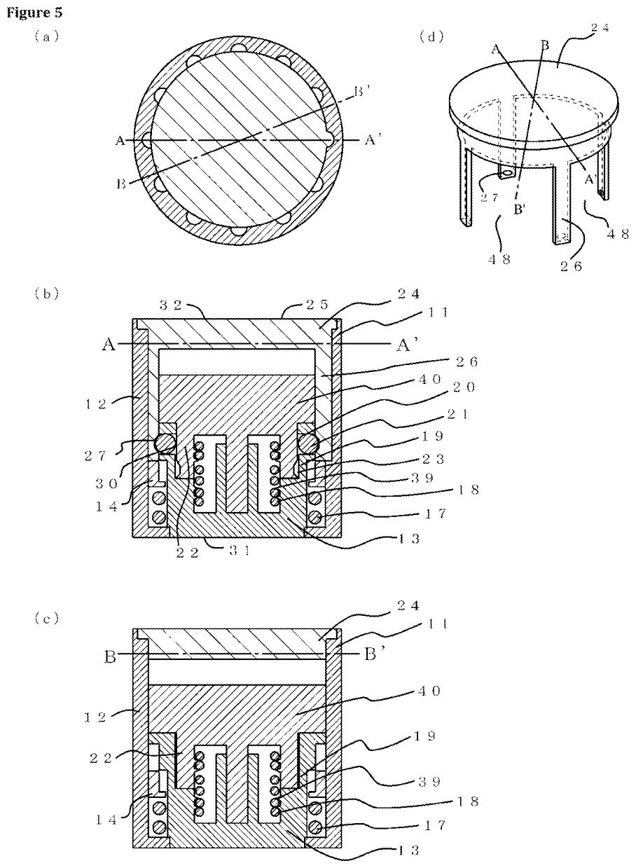

FIG. 5 describes an example of the above attempt. The integrated part of the depression-side magnet 16 and the magnet support portion 15 is defined as a magnetic material support portion 40. Part (d) of FIG. 5 is a perspective view of a detachable portion 24 produced with this new attempt. It can be seen that the skirt portion 26 of the detachable portion is provided with an opening 48 in the depth direction. The skirt portion 26 has a ball mating indentation 27, which has a function of catching the detachable portion 24 by the depressed portion 11, but it is shaped in a manner that the minimum portion is left to achieve such function and the remaining portion is removed due to the opening 48 in the depth direction. Thus, when the detachable portion 24 is inserted into the depressed portion 11, a new space as large as the opening 48 is created inside the depressed portion. If the periphery of the magnetic material support portion 40 is extended to the created space, the diameter of the magnetic material support portion 40 can be increased to the extent of the inner surface of the outer shell member so that the volume of the magnetic material can be increased.

The above is described with a sectional view. Parts (a), (b) and (c) of FIG. 5 show sectional views of the detachable portion 24 and the depressed portion 11 in the state in which no magnetic field is acting and the detachable portion 24 is caught by the depressed portion 11. Part (b) of FIG. 5 is a longitudinal sectional view cut along the A-A′ line (See parts (a) and (b) of FIG. 5) in the depth direction, where the skirt portion 26 is not provided with an opening 48. This sectional view shows a sectional view of the skirt portion of the detachable portion 24. In this section, it can be seen that the ball 21 mates with the ball mating indentation 27 created on the inner side surface of the skirt portion, and that the function of engagement of the detachable portion 24 with the depressed portion 11 is being achieved. Part (c) of FIG. 5 is a longitudinal sectional view cut along the B-B′ line (See parts (a) and (d) of FIG. 5) in the depth direction in the section of the opening 48 in the skirt portion 26 of the detachable portion. In this section, the skirt portion 26 cannot be seen due to the opening 48, but alternatively, in the space created in the opening 48, the magnetic material support portion 40 can be increased to the extent of the inner surface of the outer shell member 12. With such creativity in terms of the structure, the volume of the magnetic material support portion 40 can be increased, allowing for the achievement of an increase in the attracting force. The present invention can contribute to the stability of the movement of the replaceable mold part.

In this example, although the shape of the skirt portion is altered significantly, the essential matters of the fixation mechanism of the detachable portion to the depressed portion do not change from those described with reference to FIG. 4 nor, similarly, do the essential matters of the release mechanism change therefrom. For this reason, the descriptions are omitted and the descriptions with reference to FIG. 4 are substituted.

### Second Embodiment

Two types of design are shown due to some differences in the mechanical structure to achieve catch of the detachable portion 24 by the depressed portion 11. The above first embodiment sets forth the type of replaceable mold part that the first bias means 18 is inside of the second bias means 17, which is hereinafter defined as “cylinder shape” since the magnet support portion 15 or the magnetic material support portion 40 is in cylinder-shaped geometry at the center of the depressed portion 11. The second embodiment describes the type of replaceable mold part that the first bias means 18 is outside of the second bias means 17. The second embodiment is hereinafter defined as “ring shape” and distinguished since the magnet support portion 15 or the magnetic material support portion 40 is in ring-shaped geometry at the center of the depressed portion 11.

### Structure of Ring Shape (Pull Type) Marking Mold

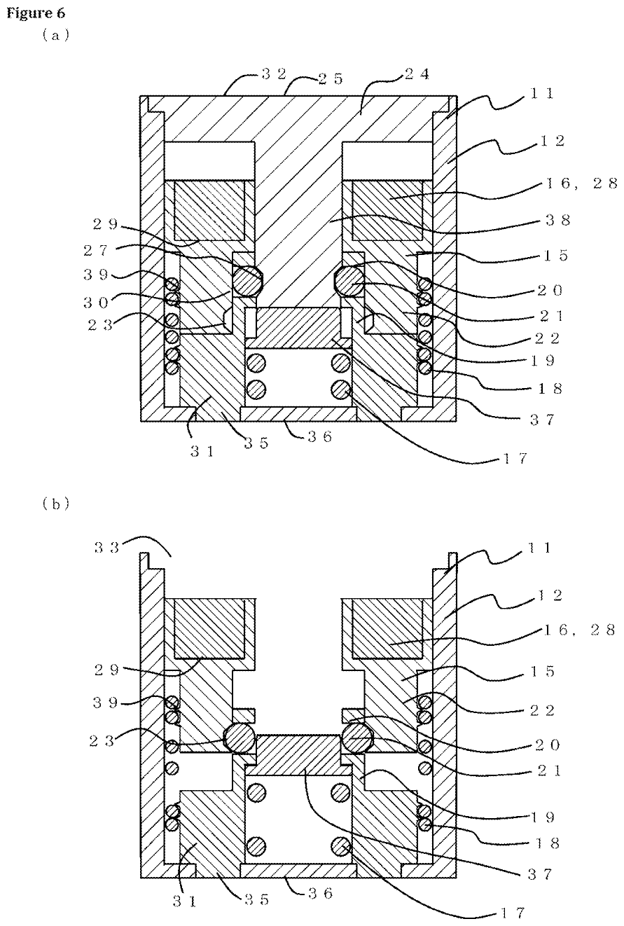

Although there are push type and pull type for the ring shape, respectively; however, for simplicity of the description, focus is placed on the pull type and the pull type is described here. Part (a) of FIG. 6 shows a sectional view of the state in which no magnetic field acts on the detachable portion 24 in the marking mold part that falls under the ring shape, pull type and that the detachable portion 24 is fixed to the depressed portion 11. Part (b) of FIG. 6 shows a sectional view of the state in which the detachable portion 24 is released from the depressed portion 11.

The depressed portion 11 comprises an outer shell member 12, an annular cover member 35, a center cover member 36, a pushing portion 37, a magnet support portion 15, a depression-side magnet 16 or a magnetic material piece 28, and a first bias means 18 and a second bias means 17.

The outer shell member 12 is tube-shaped outer shell located in the outermost shell.

The annular cover member 35 is engaged with an end of the outer shell member 12 to form part of the bottom surface of the tube, and comprises a bottom and an inner tube 19 extending in a tube shape from the bottom toward the opening of the depressed portion, where the inner tube 19 is provided with at least one ball inlet 20 on the side surface and a ball 21 corresponding to the ball inlet.

The center cover member 36 is engaged so that the opened center portion of the annular cover member 35 is covered and the bottom of the outer shell member 12 is sealed. The second bias means 17 is provided directly above and in contact with the center cover member 36, and the pushing portion 37 is placed directly above the second bias means 17, so that the pushing portion 37 is biased toward the opening of the depressed portion by the second bias means 17.

The magnet support portion 15 conforms to the annular shape. The magnet support portion 15 is inserted inside of the outer shell member 12 so that the axial portion 38 (described later) of the detachable portion 24 is inserted into the hole of the magnet support portion 15. These three portions are slidably in contact with each other in the depth direction.

The magnet support 15 comprises a support face 29 for supporting the depression-side magnet 16 or the magnetic material piece 28 near the opening of the depressed portion and an extension portion 22 extending toward the bottom side. The depression-side magnet 16 or magnetic material piece 28 is arranged on the magnet support portion 15. The extension portion 22 is inserted through the opening of the depressed portion into the outer shell of the inner tube 19 in the cover member, and the inner side surface of the extension portion is slidably in contact with the outer side surface of the inner tube.

There is a ball relief 23 at at least one location in the inner side surface of the extension portion 22 and in the proximity of the bottom of the depressed portion in the depth direction. The first bias means 18 is interposed between the magnet support portion 15 and the annular cover member 35 outside of the magnet support portion 15, and the first bias means 18 biases the magnet support portion 15 downward toward the bottom of the depressed portion.

The detachable portion 24 is inserted into the outer shell member 12 through the opening 33 of the depressed portion. The detachable portion 24 comprises a top wall 25 forming an end of the outer shell member 12, and an axial portion 38 extending in an axial shape from the top wall 25 in the direction toward the bottom. The upper end of the axial portion is slidably in contact with the inner side of the ring of the magnet support portion 15, and the lower end of the axial portion is slidably in contact with the inner side of the inner tube that extends from the annular cover member 35.

The lower surface of the axial portion is in contact with the upper surface of the pushing portion 37 and biased by the second bias means 17 through the pushing portion 37 in the direction toward the opening of the depressed portion, and the side surface of the lower end of the axial portion is provided with at least one ball mating indentation 27. The function portion 32 is located on the top wall 25, and provides a function such as marking.

### Movement of Ring Shape (Pull Type) Marking Mold

When no magnetic field acts on the replaceable mold part according to the present invention, the magnet support portion 15 is pulled toward the bottom of the depressed portion by the first bias means 18. At this location, the ball 21 abuts against the abutment face 30 of the extension portion 22 of the magnet support portion, and part of the ball 21 projects from the ball inlet 20 into the ball mating indentation 27 provided in the skirt portion 26 and caught thereby, so that the detachable portion 24 is fixed within the depressed portion 11.

This structure is maintained by the force that the pushing portion 37 biased upward by the second bias means 17 pushes the lower end of the axial portion 38. Thus, stress is applied to the ball 21 through the ball mating indentation 27 so that the ball 21 is tightly fitted in the space surrounded by the abutment face 30, the ball inlet 20 and the ball mating indentation 27 while the detachable portion 24 is tightly fixed to the depressed portion 11.

If the operation magnet 5 is brought into proximity, the magnet support portion 15 is pulled toward the opening of the depressed portion by the attracting force. The first bias means 18 is then extended, and the magnet support portion 15 moves to a position close to the opening of the depressed portion. The polarity of the operation magnet that is directed toward the replaceable mold part is an S pole if there is a depression-side magnet 16; however, the polarity of the operation magnet may be either an S pole or an N pole if a magnetic material piece is used.

Part (b) of FIG. 6 shows the state after the movement. The ball 21 moves laterally from the ball mating indentation 27 of the axial portion toward the ball relief 23 provided on the side surface of the magnetic material support portion. When located closer to the ball relief 23, away from the location of the ball inlet 20, the ball 21 is disengaged from the catch by the ball mating indentation 27, thereby the fixation of the detachable portion 24 to the depressed portion 11 is released.

Since the axial portion 26 is constantly biased toward the opening of the depressed portion, the axial portion 26 moves in the same direction. As a result, the top of the detachable portion 24 projects beyond the surface of the cavity in the mold base, thereby the projecting portion can be grabbed to remove the detachable portion 24.

When the detachable portion 24 is attached to the depressed portion 11, the detachable portion 24 is inserted through the opening of the depressed portion in the state of part (b) of FIG. 6 and the ball 21 is mated with the ball mating indentation 27 once again, which results in the removal of the ball from the ball relief 23. Thus, the detachable portion can return to the caught state as shown in part (a) of FIG. 6.

One merit of the ring shape, as compared to the cylinder shape, is its easiness in producing the pull type. During the production of the pull type, there is an issue with the process of producing a fixture piece 39 for fixing a coil spring, that serves as the first bias means, to the side surface of the magnet support portion. In the ring shape, the fixture piece 39 is produced on the outer side surface of the tube shape of the magnet support portion 15 via turning process, but since it is outside the tube, it is easy to cut by bringing a cutter into contact therewith from the outside during the process. In contrast, in the cylinder shape, since the fixture piece 39 is on the inner surface of the tube shape, it must be cut by entering a cutter inside the hole that has been made and bringing this cutter in contact with the inner wall to produce the fixture piece 39. This process requires the use of a cutter with a special shape, and a tube with a smaller diameter causes more difficulties in the process. For reasons as stated above, the ring shape is easy to produce and has high mass productivity as compared with the cylinder shape.

To the contrary, there are also some advantages of the cylinder shape. The cylindrical shape does not require a hole to be provided at the center of the magnet support portion 15 unlike the ring shape, and therefore, a depression-side magnet 16 or a magnetic material piece 28 having a larger volume may be used for the cylinder shape. Thus, a strong interaction force can be utilized to move the magnet, which results in stable movement.

In consideration of these perspectives, among the four types described previously, including push type/pull type and ring shape/cylinder shape, the one that has an assured movement without the use of an interior magnet, which allows for the avoidance of issues with an interior magnet, and is easy to produce is the pull type, ring shape that uses a magnetic material instead of a magnet. The features stated previously are summarized in a table, respectively.

TABLE 1

| Push/ | Ring/ | | | Easy |
|---|---|---|---|---|
| Pull | Cylinder | Magnet | Stability | Production |
| Push | Ring | Required | ◯ | ◯ |
| | Cylinder | Required | ⊚ | ◯ |
| Pull | Ring | Not Required | ◯ | ◯ |
| | Cylinder | Not Required | ⊚ | X |

### Third Embodiment

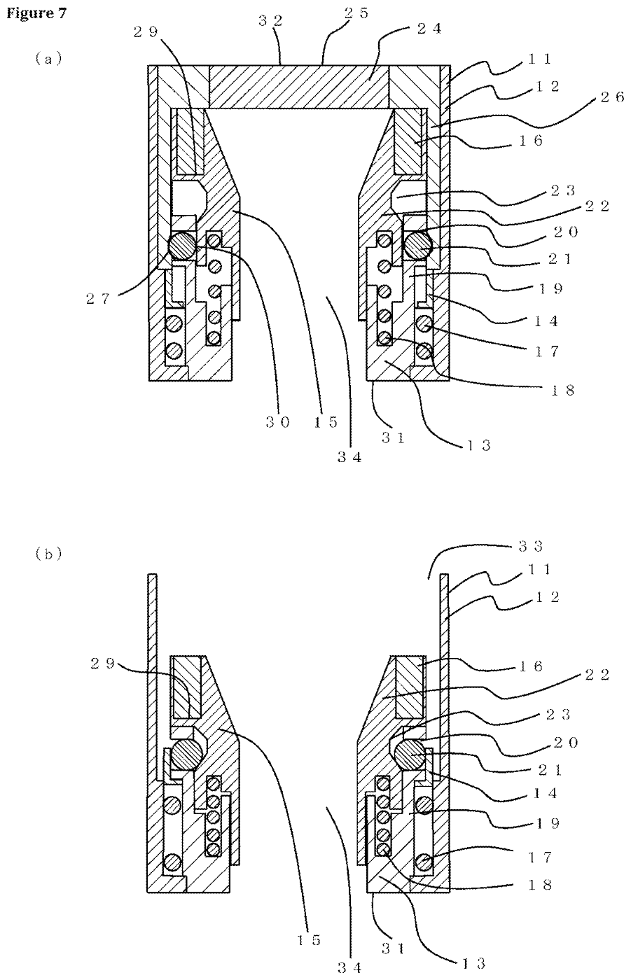

Thirdly, the gas-releasing mold part is described with reference to the drawings, in a similar manner. FIG. 7 shows a longitudinal sectional view of a push type gas-releasing mold part. Those members that have similar functions or effects to those of the components described for the push type as shown in FIG. 3 are denoted by the same reference numerals, and their descriptions are omitted. The fixture mechanism of the detachable portion to the depressed portion in the push type gas-releasing mold part does not differ from that of the marking mold part nor, similarly, does the release mechanism differ therefrom. For this reason, the descriptions of the fixture mechanism and the release operations with reference to the marking mold part as stated previously can be substituted as they are.

One difference from the marking mold part is that a through hole is provided so that gas can flow in the depth direction, from the function portion of the detachable portion toward the bottom surface of the depressed portion. Followings are four specific differences. Firstly, the magnet support portion 15 is provided with a through hole 34 that penetrates in the depth direction; secondly, the depression-side magnet 16 is arranged in a ring shape surrounding the through hole; thirdly, the cover member 13 is provided with a through hole at the bottom; and fourthly, the top wall 25 is provided with a through hole, so as to configure the function portion 32.

In the top wall 25 that serves as the function portion 32, the diameter of the through hole is so fine that the gas generated from molten resin is able to pass therethrough but the resin is unable to pass therethrough due to its viscosity. A number of through holes are made to ensure the conductance of gas. Even if such through holes are blocked for some reason, the gas-releasing mold part according to the present invention enables easy cleaning of the fine through holes for releasing gas without the need for disassembling the mold since the detachable portion comprising the through holes can be removed and reattached through the cavity while the mold base is opened.

### Fourth Embodiment

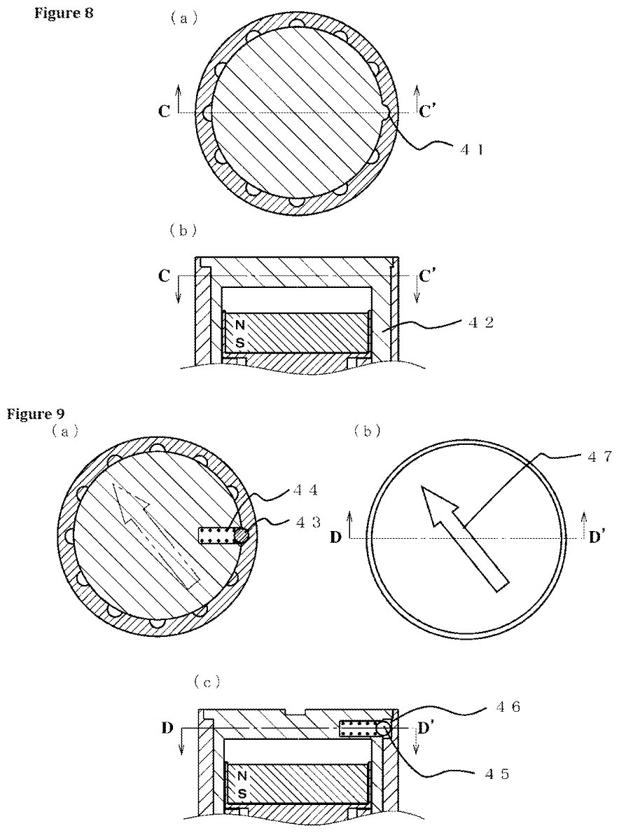

Fourthly, the positioning ridge that projects laterally beyond the side surface of the detachable portion is described with reference to FIG. 8. In this mold part, as shown in the transverse sectional view in part (a) of FIG. 8, when the detachable portion 24 has a cylinder shape, the detachable portion 24 may rotate around the central axis that penetrates the cylindrical shape in the depth direction. The rotation can be prevented by providing a positioning ridge 41, which allows for the fixation of the direction of the inner surface of the cavity in the function portion 32.

In the example shown in part (a) of FIG. 8, the positioning ridge 41 is in the 3 o'clock direction. Part (b) of FIG. 8 shows a longitudinal sectional view of a mold part cut along the C-C′ line. Positioning ridges 41 are formed to extend in the depth direction, and positioning grooves 42 are provided to the inner wall of the outer shell member that correspond to the positioning ridges 41, so as to mate with the positioning ridges 41. Since the positioning grooves 42 are provided by 30 degree increments around the circumference of the outer shell member, the detachable portion 24 can be fixed at a desired angle.

FIG. 9 shows positioning projections 43 formed with a similar concept. As shown in the D-D′ sectional view in part (b) of FIG. 9, the positioning projections 43 are in the 3 o'clock direction. The positioning projections 43 project laterally beyond the side surface of the detachable portion, and comprise a positioning spring 44 embedded under the side surface of the detachable portion and a fitting portion 45 disposed on the positioning spring 44. Part (c) of FIG. 9 shows a sectional view of a mold part cut along the D-D′ line. The outer shell member is provided with a positioning indentation 46 on the inner surface, that corresponds to a positioning projection 43, and the fitting portion 45 is fitted therein.

Although the fitting portion 45 is projected outwardly beyond the side surface of the detachable portion 24 by the positioning spring 44 in this configuration, this projection can also be embedded inside the side surface of the detachable portion 24 by the contraction of the positioning spring 44. As shown in the top plan view of the mold part in part (a) of FIG. 9, when a strong rotational force is applied to the rotational axis that penetrates the cylinder of the detachable portion 24 in the depth direction, by inscribing an arrow mark 47 on the top wall 25 of the function portion 24 and rotating it with a screwdriver or the like, it allows for the rotation of the detachable portion 24 as the mating portion 45 is embedded inside the side surface of the detachable portion by the rotational force and the obstacle for the rotation is removed. The rotation of the detachable portion 24 is suspended in this position when the fitting portion 45 fits into the following positioning indentation 46 provided around the inner circumference of the side surface of the outer shell member 12, and the detachable portion 24 is fixed and no further movement occurs by the weak force of the external disturbance. That is, in the configuration of the positioning projection shown in FIG. 9, the cylindrically-shaped detachable portion can be rotated symmetrically around the central axis that penetrates the cylindrical shape in the depth direction without the need for removing the cylindrically-shaped detachable portion by a magnet, and, moreover, the detachable portion itself has the replaceable feature if needed.

### Fifth Embodiment

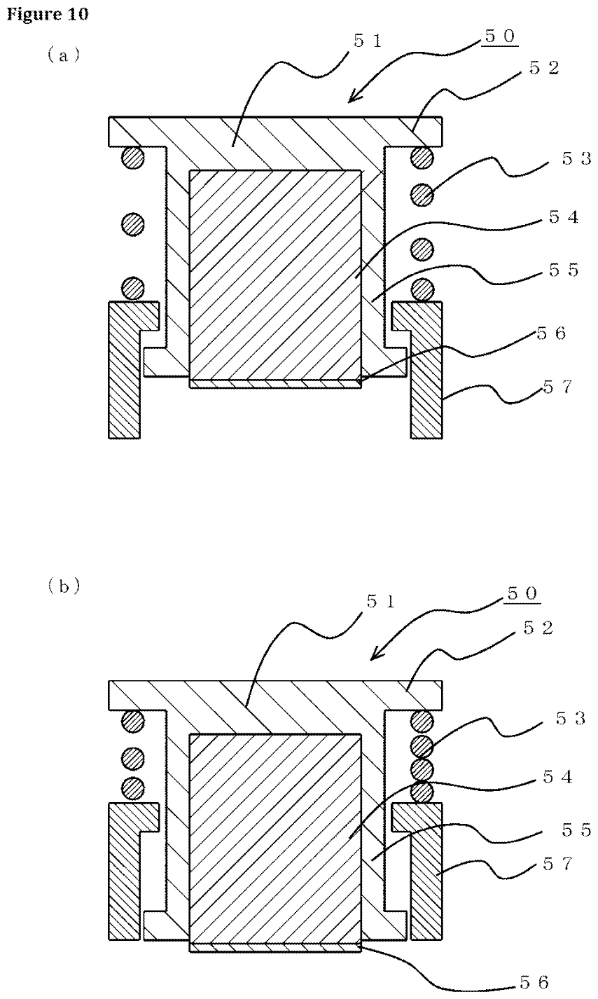

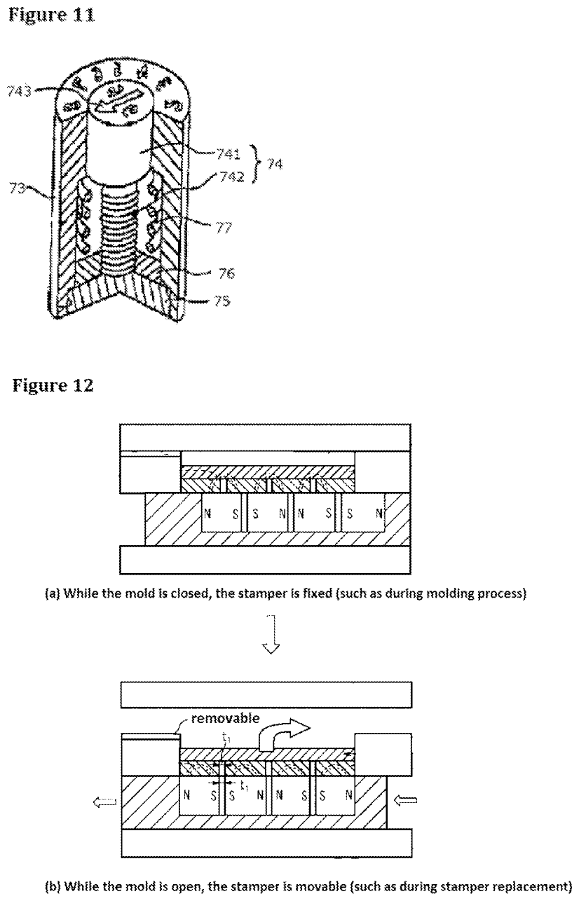

Fifthly, the operation-magnet handling jig 50 is described with reference to FIG. 10. This jig 50 is for bringing the operation magnet 54 into proximity of the mold part. This jig 50 comprises a magnet-holding container 51, a positioning base 57, a third bias means 53, an operation magnet 54, and a buffer sheet 56. In this embodiment, either a permanent magnet or an electromagnet may be used as the operation magnet 54.

The magnet-holding container 51 comprises a flanged planar portion 52 on the upper surface and a magnet-accommodating tube 55 extending downward from the flanged planar portion 52, in which the operation magnet 54 is accommodated inside the magnet-accommodating tube 55 and the buffer sheet 56 is bonded to the lower surface of the operation magnet 54.

The positioning base 57 has a tube shape with openings in the upper surface and the lower surface. The magnet-holding container 51 accompanied by the operation magnet 54 is slidably fitted through the opening in the upper surface of the positioning base. The third bias means 53 is interposed between the upper surface of the positioning base 57 and the flanged planar portion 52 of the magnet-holding container 51, and the distance between the lower end of the positioning base 57 and the lower end of the operation magnet 54 is maintained and adjusted by the repelling force urged by the third bias means 53.

In case the operation magnet 54 is brought into contact with the surface of the cavity by a strong force, the buffer sheet 56 serves as protection of the surface of the cavity from damage. The jig 50 stands on the surface of the cavity in the mold base in the state as shown in part (a) of FIG. 10 and is positioned to locate the operation magnet 54 directly above the replaceable mold part, and then the operation magnet 54 is brought into a close distance to the replaceable mold part as shown in part (b) of FIG. 10, to move the depression-side magnet 16 within the replaceable mold part and remove the detachable portion 24.

The use of the jig 50 enables the positioning to accurately locate the operation magnet 54 directly above the replaceable mold part, which allows for the protection of the surface of the cavity from inadvertent damage.

### INDUSTRIAL APPLICABILITY

The replaceable mold part according to the present invention provides a replaceable mold part that allows for the easy replacement of the mold part having given functions, not limited to a marking face of any shape such as square or a gas-releasing part, through the cavity even while the mold base is in the open state without the need for removing the mold base itself, which carries a heavy weight, from the injection molding machine; disassembling the mold; inscribing a groove on the marking face to engage a slotted screwdriver in order to attach or detach the marking face; forming a special structure within the mold base, such as magnetic movement; or significantly modifying the mold base itself. The present invention can contribute to the improvement of the efficiency of resin molding process using a mold part.

The replaceable mold part according to the present invention is preferably used as a marking mold part for marking the surface of a molded article during the resin molding process using a mold or a gas-releasing mold part for releasing gas generated inside a mold.

### EXPLANATIONS OF REFERENCES

2 Indentation
3 Gas-releasing mold part
4 Marking mold part
5 Operation magnet
6 Detachable portion
7 Vent hole
11 Depressed portion
12 Outer shell member
14 Outer tube
15 Magnet support portion
16 Depression-side magnet
17 Second bias means
18 First bias means
19 Inner tube
20 Ball inlet
21 Ball
22 Extension portion
23 Ball relief
24 Detachable portion
25 Top wall
26 Skirt portion
27 Ball mating indentation
28 Magnetic material piece
29 Support face
30 Abutment face
31 Bottom
32 Function portion
34 Through hole
37 Pushing portion
38 Axial portion
41 Positioning ridge
42 Positioning groove
43 Positioning projection
44 Positioning spring
45 Fitting portion
46 Positioning indentation
50 Operation-magnet handling jig
51 Magnet-holding container
53 Third bias means
54 Operation magnet
56 Buffer sheet
57 Positioning base

1. A replaceable mold part to be attached to an indentation near a cavity in a mold base for molding process, the replaceable mold part comprising:
a depressed portion provided in the indentation and remained in the cavity; and
a detachable portion inserted into the depressed portion through the cavity and switched between a fixed state and a released state with respect to the depressed portion,
wherein the depressed portion comprises a magnet support portion sliding in a depth direction of the depressed portion and supporting a depression-side magnet or a magnetic material piece,
wherein the depressed portion further comprises a catch mechanism switching the detachable portion to the fixed state by catching the detachable portion by the depressed portion while switching the detachable portion to the released state by releasing the catch,
wherein the depressed portion has a first bias means for biasing a force to control movement of the detachable portion from a fixed position to a released position,
wherein the magnet support portion is provided with a fixed position and a released position of the catch mechanism,
wherein the detachable portion comprises a function portion for achieving a given function, and
wherein a magnetic field generated by an external magnetic field generating means overcomes the force of the first bias means to control, thereby shifting the magnet support portion from the fixed position to the released position.

2. The replaceable mold part according to claim 1, wherein the function portion comprises a marking portion for marking a molded article and a gas-releasing portion for releasing gas remaining inside the cavity to outside.

3. The replaceable mold part according to claim 1, wherein when, through the cavity, an operation magnet is brought into proximity of the detachable portion fixed to the depressed portion, the magnet support portion is configured to move from the fixed position to the released position by a repelling force between the depression-side magnet and the operation magnet.

4. The replaceable mold part according to claim 1, wherein when, through the cavity, an operation magnet is brought into proximity of the detachable portion fixed to the depressed portion, the magnet support portion is configured to move from the fixed position to the released position by an attracting force between the depression-side magnet or the magnetic material piece and the operation magnet.

5. The replaceable mold part according to claim 1, wherein the fixed position of the magnet support portion is provided at a position near an opening of the depressed portion, and the released position of the magnet support portion is provided at a position near a bottom of the depressed portion.

6. The replaceable mold part according to claim 1, wherein the released position of the magnet support portion is provided at a position near an opening of the depressed portion, and the fixed position of the magnet support portion is provided at a position near a bottom of the depressed portion.

7. The replaceable mold part according to claim 1, wherein the depressed portion has a tube-shaped outer shell member accommodated in the indentation, an inner tube provided inside the outer shell member, and the depression-side magnet,
wherein the catch mechanism comprises at least one ball,
wherein the inner tube is provided with at least one ball inlet on a side surface of the inner tube,
wherein the magnet support portion has a support face supporting the depression-side magnet near an opening of the depressed portion and an extension portion extending toward a bottom of the depressed portion,
wherein the extension portion is provided with an abutment face corresponding to the fixed position, and at least one ball relief corresponding to the released position, that is provided near the opening of the depressed portion than the abutment face, on an outer side surface of the extension portion,
wherein the detachable portion has a top wall and a skirt portion extending in a tube shape toward the bottom of the depressed portion,
wherein the skirt portion is provided with at least one ball mating indentation on an inner side surface of the skirt portion,
wherein the first bias means intervenes between the bottom of the depressed portion and the lower end of the extension portion,
wherein when located on the abutment face, the ball projects from the ball inlet into the ball mating indentation and is caught thereby, so that the fixed state is achieved, and
wherein when located closer to the ball relief, away from the location of the ball inlet, the ball is disengaged from the catch by the ball mating indentation, so that the released state is achieved.

8. The replaceable mold part according to claim 1, wherein the depressed portion has a tube-shaped outer shell member accommodated in the indentation, an inner tube provided inside the outer shell member, and the depression-side magnet or magnetic material piece,
wherein the catch mechanism comprises at least one ball,
wherein the inner tube is provided with at least one ball inlet on a side surface of the inner tube,
wherein the magnet support portion has a support face supporting the depression-side magnet or the magnetic material piece near the opening of the depressed portion and an extension portion extending toward a bottom of the depressed portion,
wherein the extension portion is provided with an abutment face corresponding to the fixed position, and at least one ball relief corresponding to the released position, that is provided near the bottom of the depressed portion than the abutment face, on an outer side surface of the extension portion,
wherein the detachable portion has a top wall and a skirt portion extending in a tube shape toward the bottom of the depressed portion,
wherein the skirt portion is provided with at least one ball mating indentation on an inner side surface of the skirt portion, wherein the first bias means intervenes between the bottom of the depressed portion and the extension portion,
wherein when located on the abutment face, the ball projects from the ball inlet into the ball mating indentation and is caught thereby, so that the fixed state is achieved, and
wherein when located closer to the ball relief, away from the location of the ball inlet, the ball is disengaged from the catch by the ball mating indentation, so that the released state is achieved.

9. The replaceable mold part according to claim 1, wherein the replaceable mold part has a tube-shaped outer tube inserted inside the outer shell member and positioned outside in a state of surrounding the inner tube, and
wherein the outer tube is biased by a second bias means interposed between a bottom of the outer tube and a bottom of the outer shell member in the direction toward the opening of the depressed portion.

10. The replaceable mold part according to claim 1, wherein the depressed portion has a tube-shaped outer shell member accommodated in the indentation, an inner tube provided inside the outer shell member, and the depression-side magnet in a ring shape,
wherein the catch mechanism comprises at least one ball, wherein the inner tube is provided with at least one ball inlet on a side surface of the inner tube,
wherein the magnet support portion conforms to a ring shape, and has a support face supporting the depression-side magnet near the opening of the depressed portion and an extension portion extending toward a bottom of the depressed portion,
wherein the extension portion is provided with an abutment face corresponding to the fixed position, and at least one ball relief corresponding to the released position, that is provided near the face of the opening of the depressed portion than the abutment face, on an inner side surface of the extension portion,
wherein the detachable portion has a top wall and an axial portion extending in an axial shape toward the bottom of the depressed portion,
wherein the axial portion is provided with at least one ball mating indentation on an outer side surface of the axial portion,
wherein the first bias means intervenes between the bottom of the depressed portion and the extension portion,
wherein when located on the abutment face, the ball projects from the ball inlet into the ball mating indentation and is caught thereby, so that the fixed state is achieved, and
wherein when located closer to the ball relief, away from the location of the ball inlet, the ball is disengaged from the catch by the ball mating indentation, so that the released state is achieved.

11. The replaceable mold part according to claim 1, wherein the depressed portion has a tube-shaped outer shell member accommodated in the indentation, an inner tube provided inside the outer shell member, and the depression-side magnet or the magnetic material piece in a ring shape,
wherein the catch mechanism comprises at least one ball,
wherein the inner tube is provided with at least one ball inlet on a side surface of the inner tube,
wherein the magnet support portion conforms to a ring shape, and has a support face supporting the depression-side magnet or the magnetic material piece near the opening of the depressed portion and an extension portion extending toward a bottom of the depressed portion,
wherein the extension portion is provided with an abutment face corresponding to the fixed position, and at least one ball relief corresponding to the released position, that is provided near the bottom of the depressed portion than the abutment face, on an inner side surface of the extension portion,
wherein the detachable portion has a top wall and an axial portion extending in an axial shape toward the bottom of the depressed portion,
wherein the axial portion is provided with at least one ball mating indentation on an outer side surface of the axial portion,
wherein the first bias means intervenes between the bottom of the depressed portion and the extension portion,
wherein when located on the abutment face, the ball projects from the ball inlet into the ball mating indentation and is caught thereby, so that the fixed state is achieved, and
wherein when located closer to the ball relief, away from the location of the ball inlet, the ball is disengaged from the catch by the ball mating indentation, so that the released state is achieved.

12. The replaceable mold part according to claim 1, wherein the replaceable mold part has a pushing portion slidably inserted inside the inner tube and facing a bottom of the depressed portion,
wherein the pushing portion is biased by a second bias means interposed between a bottom of the pushing portion and the bottom of the depressed portion in the direction toward the opening of the depressed portion.

13. The replaceable mold part according to claim 1, wherein the replaceable mold part is provided with a through hole penetrating the detachable portion and the depressed portion, and the mold base is provided with a vent hole communicating with the through hole in the depressed portion in advance, and
wherein the depression-side magnet or the magnetic material piece is disposed in a manner to avoid the disposal position of the through hole.

14. The replaceable mold part according to claim 1, wherein the detachable portion is provided with at least one positioning ridge on a side surface of the detachable portion, that projects laterally against the outer shell member, and
wherein the outer shell member is provided with at least one positioning groove in the inner wall of the outer shell member, that extends in the depth direction while enabling the positioning ridge to be fitted therein.

15. The replaceable mold part according to claim 1, wherein the detachable portion is provided with at least one positioning projection on a side surface of the detachable portion, that projects laterally against the outer shell member,
wherein the positioning projection comprises a positioning spring embedded under the side surface of the detachable portion and a fitting portion disposed on the positioning spring, and
wherein at least one positioning indentation is formed on the inner surface of the outer shell member, that enables the fitting portion to be fitted therein.

16. The replaceable mold part according to claim 1 that has an operation magnet handling jig, wherein the replaceable mold part is equipped with a magnet-positioning means for locating the operation magnet directly above the replaceable mold part of the mold base for molding process, and a distance altering means for altering the distance between the operation magnet and the replaceable mold part.

17. The replaceable mold part according to claim 16 that has an operation magnet handling jig, wherein the operation magnet handling jig comprises a magnet-holding container, a positioning base, a third bias means, an operation magnet, and a buffer sheet,
wherein the operation magnet is accommodated inside the magnet-holding container,
wherein the buffer sheet is bonded to the lower surface of the operation magnet,
wherein the magnet-holding container accompanied by the operation magnet is slidably fitted in the positioning base, and
wherein the distance between the lower end of the positioning base and the lower end of the operation magnet is maintained by a repelling force urged by the third bias means interposed between the positioning base and the magnet-holding container.
